(19) United States
(12) Patent Application Publication
(10) Pub. No.: US 2009/0112407 A1
(43) Pub. Date: Apr. 30, 2009

(54) System and Method for Communication by Architecture

(75) Inventors: Heidi J. Kneller, Bellevue, WA (US); Calsee N. Robb, Seattle, WA (US); William A. Harkness, Everett, WA (US); Buddy L. Sharpe, Mill Creek, WA (US); James P. Schalla, Edmonds, WA (US)

Correspondence Address: HARNESS DICKEY & PIERCE, PLC, P.O. BOX 828, BLOOMFIELD HILLS, MI, 48303, US

(73) Assignee: The Boeing Company, Chicago, IL (US)

(21) Appl. No.: 11/927,540

(22) Filed: Oct. 29, 2007

(51) Int. Cl. G06F 17/00

(52) U.S. Cl. 701/45; 701/36

(57) ABSTRACT

A system for communicating with passengers onboard a mobile platform (such as a train, marine vessel, aircraft or automobile) using at least one structure onboard the mobile platform is provided. The system includes at least one seat for receipt of the at least one passenger. The seat includes a seatbelt that is operable to be fastened to retain the at least one passenger in the seat. The system also includes at least one source of data regarding a status of the mobile platform, and a structure control module that generates communication data for at least the seatbelt based on the status of the mobile platform. The communication data may be operable to communicate to the at least one passenger by the seatbelt that the seatbelt is to be fastened.

### FIELD

The present disclosure relates generally to communication systems onboard a mobile platform, and more particularly to a system and method for communication by or with architecture onboard a mobile platform.

### BACKGROUND

The statements in this section merely provide background information related to the present disclosure and may not constitute prior art.

Many mobile platforms (such as trains, ships, aircraft and automobiles) are required to display, announce, or otherwise broadcast safety or status information in a conspicuous manner so that their passengers may review this information and be reminded of it during their voyage. For example, commercial passenger aircraft, are required to display information instructing the passengers to fasten their seatbelts and remain seated during take-off, landing and times of turbulence.

In order for this displayed information to be understood by everyone, placards may be used that include instructions in various languages and may be ineffectual for the visually impaired. Announcements may be considered obtrusive, hard to hear, and ineffectual for the hearing impaired. Alternatively, symbols might be used to convey to the passenger that the seatbelt is to be fastened. Both the use of placards and symbols may be limited for those passengers with disabilities, such as nearsightedness, it may be difficult for these passengers to see and/or read the placards and symbols. Further, the use of placards may be quite costly due to the numerous languages that the placards must be printed in and part numbers that must be maintained.

### SUMMARY

A system communicating with at least one passenger onboard a mobile platform by using at least one structure onboard the mobile platform is provided. The system includes at least one seat for receipt of the at least one passenger that includes a seatbelt that is operable to be fastened to the retain at least one passenger in the seat. The system also includes at least one source of data regarding a status of the mobile platform, and a structure control module that generates communication data for at least the seatbelt based on the status of the mobile platform. The communication data may be operable to communicate to the at least one passenger by the seatbelt that the seatbelt is to be fastened.

In one implementation, a method of communicating with passengers onboard a mobile platform by using at least one structure onboard the mobile platform is provided. The method includes receiving an input from at least one of an occupant of a control center on the mobile platform and a crew member of the mobile platform. The method further includes determining, based on the input, a message to communicate to the passengers, and selecting the at least one structure onboard the mobile platform to communicate the message. The at least one structure is selected from the group comprising flooring onboard the mobile platform, a lavatory onboard the mobile platform, a galley complex onboard a mobile platform, a seatbelt onboard the mobile platform and combinations thereof. The method also includes communicating the message to the passengers via the selected at least one structure on the mobile platform.

The present teachings also include an aircraft. The aircraft includes a fuselage that includes a cabin and a cockpit. The cabin includes at least one passenger seat having a seatbelt, at least one lavatory, at least one galley complex and flooring. The seatbelt of the at least one passenger seat, the at least one lavatory, the at least one galley complex and the flooring is controlled by a communication system. The communication system includes an architecture communication control module that generates communication data that communicates at least information received from an occupant of the cockpit to at least one passenger onboard the aircraft through the seatbelt of the at least one passenger seat, the at least one lavatory, the at least one galley complex the flooring and combinations thereof.

Also provided is a system for communicating with at least one passenger onboard an aircraft having a fuselage that includes a cabin and a cockpit. The cabin includes at least one passenger seat having a seatbelt, at least one lavatory, at least one galley complex and flooring. The system comprises at least one food service preparation device located within the galley complex. The at least one food service device includes at least one sensor. The system also includes at least one source of data regarding a status of the aircraft and at least one occupant sensor coupled to the at least one lavatory. The at least one occupant sensor is operable to transmit a signal that indicates if the at least one lavatory is occupied. The system includes a seatbelt control module that generates communication data for at least the seatbelt based on the status of the aircraft, which is operable to communicate to the at least one passenger by the seatbelt that the seatbelt is to be fastened. The system also includes a galley control module that generates communication data for at least the at least one food service preparation device that indicates that the at least one food service preparation device is ready for service and/or operating temperature. The system further comprises a lavatory control module that generates communication data for the at least one lavatory based on the signal from the at least one occupant sensor. The communication data from the lavatory control module is operable to communicate to the at least one passenger by the lavatory that the at least one lavatory is occupied or unoccupied. The system includes a flooring control module that generates communication data for the flooring such that the flooring is operable to communicate the status of the aircraft to the at least one passenger.

A method of communicating with passengers onboard an aircraft having a fuselage that includes a cockpit and a cabin is also provided. The cabin includes at least one passenger seat having a seatbelt, at least one lavatory, at least one galley complex and flooring. The method includes receiving an input from at least one of an occupant of the cockpit or a crew member of the aircraft, and determining, based on the input, a message to communicate to the passengers. The method also includes communicating the message to the passengers by at least one of: illuminating the flooring to communicate the message, illuminating at least one light source on the seatbelt to communicate the message or applying a current to the seatbelt to change a shape of the seatbelt to communicate the message, changing a door coupled to the lavatory to communicate the message and combinations thereof.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a schematic illustration of a mobile platform incorporating the system and method for communication by architecture according to the principles of the present disclosure;

FIG. 2A is a schematic illustration of an exemplary galley complex onboard the mobile platform of FIG. 1;

FIG. 2B is a schematic perspective illustration of an exemplary seatbelt for use with the architecture communication control module of FIG. 1;

FIG. 2C is a schematic illustration of the exemplary seatbelt of FIG. 2B in a second state;

FIG. 2D is a schematic illustration of the exemplary seatbelt of FIG. 2B in a second state;

FIG. 2E is a is a schematic illustration of the exemplary seatbelt of FIG. 2B in a second state;

FIG. 2F is a schematic illustration of the exemplary lavatory of FIG. 2G in a second state. The exemplary lavatory onboard the mobile platform includes door opacity generated by the architecture communication control module of FIG. 1;

FIG. 2G is a schematic illustration of the lavatory for use with the architecture communication control module of FIG. 1;

FIG. 2H is a schematic illustration of a lavatory onboard the mobile platform that includes wallpaper generated by the architecture communication control module of FIG. 1;

FIG. 2I is a schematic illustration of the exemplary flooring for the mobile platform of FIG. 1;

FIG. 2J is a schematic illustration of the flooring of FIG. 21 communicating with a passenger onboard the mobile platform;

FIG. 3 is a dataflow diagram illustrating an exemplary architecture communication control system of the present disclosure;

FIG. 4 is a dataflow diagram illustrating an exemplary structure control system of the present disclosure;

FIG. 5 is a flowchart illustrating an operational sequence for the architecture communication control system of FIG. 3;

FIG. 6 is a flowchart illustrating an operational sequence for the architecture communication control system of FIG. 3;

FIG. 7 is a flowchart illustrating an operational sequence for the architecture communication control system of FIG. 3;

FIG. 8 is a flowchart illustrating an operational sequence for the architecture communication control system of FIG. 3;

FIG. 9 is a flowchart illustrating an operational sequence for the architecture communication control system of FIG. 3; and

FIG. 10 is a flowchart illustrating an operational sequence for the architecture communication control system of FIG. 3.

### DETAILED DESCRIPTION

The following description is merely exemplary in nature and is not intended to limit the present disclosure, application, or uses. Although the following description is related generally to a system and method for communication by architecture onboard a mobile platform (such as an aircraft, ship, spacecraft, train or land-based motor vehicle), it will be understood that the system and method for communication by architecture, as described and claimed herein, may be used with any appropriate application where it would be desirable for a structure to communicate messages to an individual, such as in airports. Therefore, it will be understood that the following discussion is not intended to limit the scope of the appended claims to only mobile platforms and mobile platform based systems.

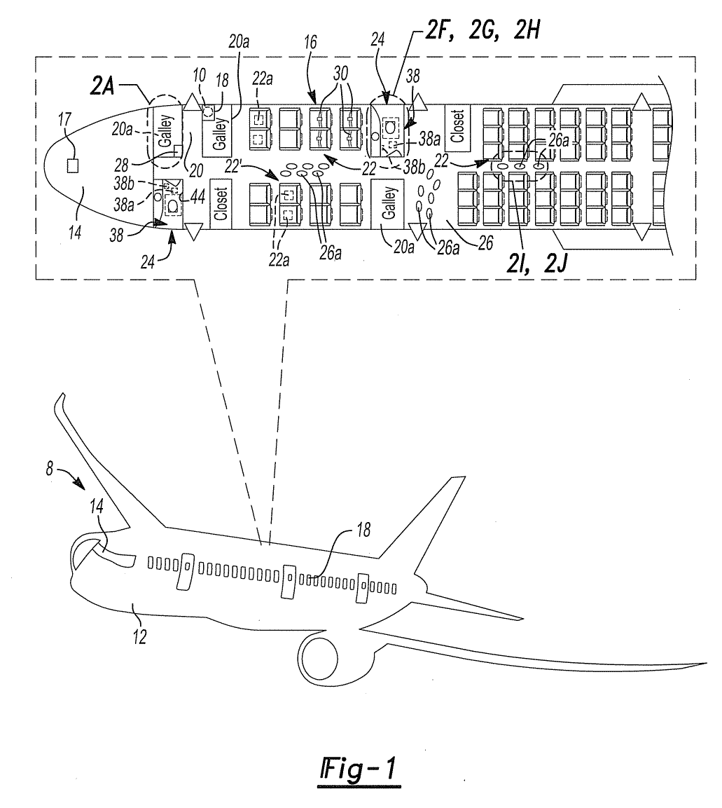

With reference to FIG. 1, a schematic illustrates an exemplary mobile platform that employs a system and a method for communication by architecture through an architecture communication control module 10. The mobile platform, in this example, is a passenger aircraft 8 that has a fuselage 12 that includes a cockpit 14, a cabin 16 and a controller 18. The cockpit 14 may include at least one user input device 19 in communication with and responsive to the controller 18 to enable the occupants of the cockpit 14 to interface with the architecture communication control module 10. The user input device 17 may comprise any suitable user input device, such as a GUI, button(s), a touch screen, a mouse, a stylus, a joystick, etc. The cabin 16 includes at least one crew area 20, at least one passenger seat 22, at least one lavatory 24 and flooring 26.

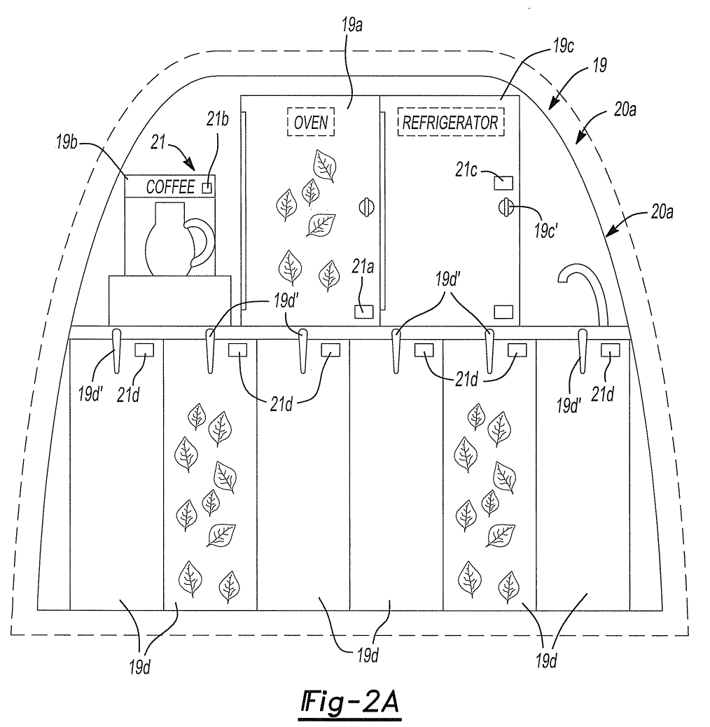

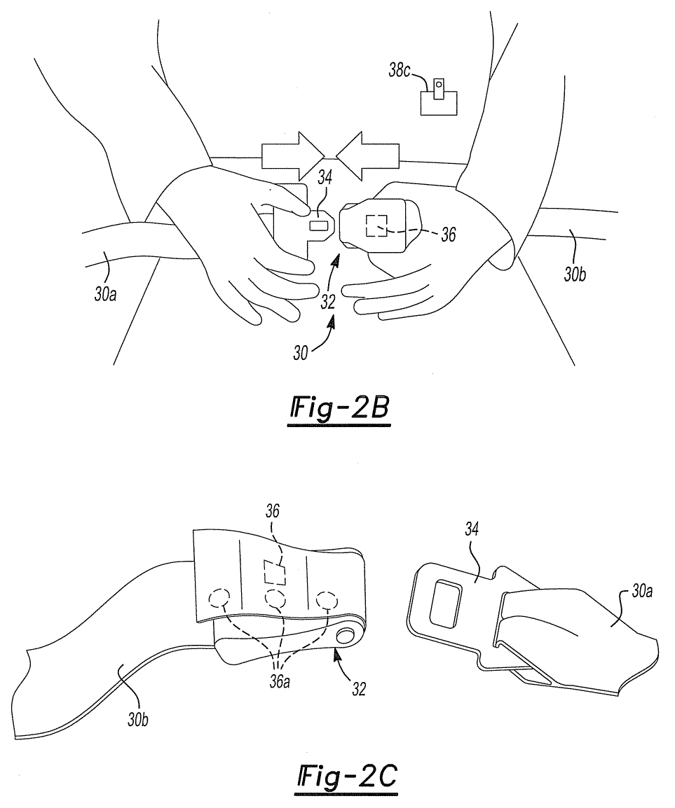

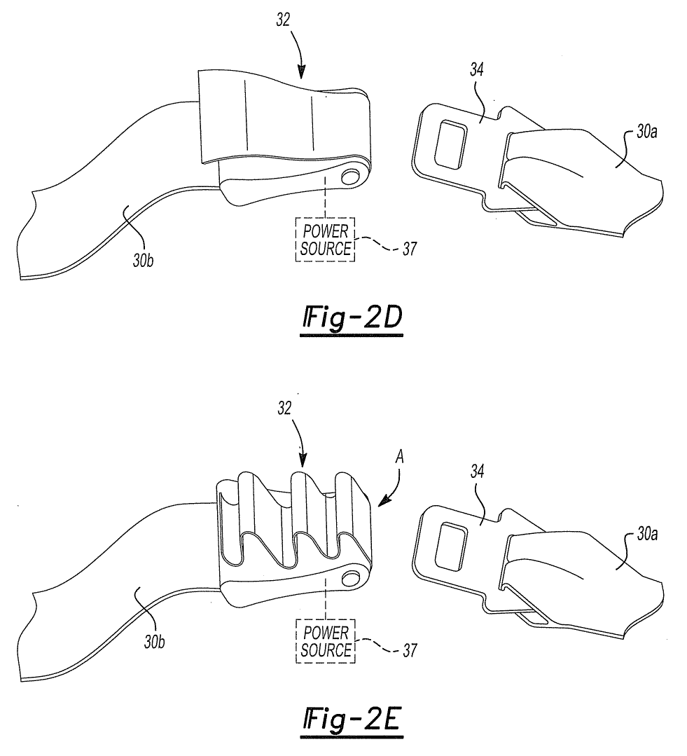

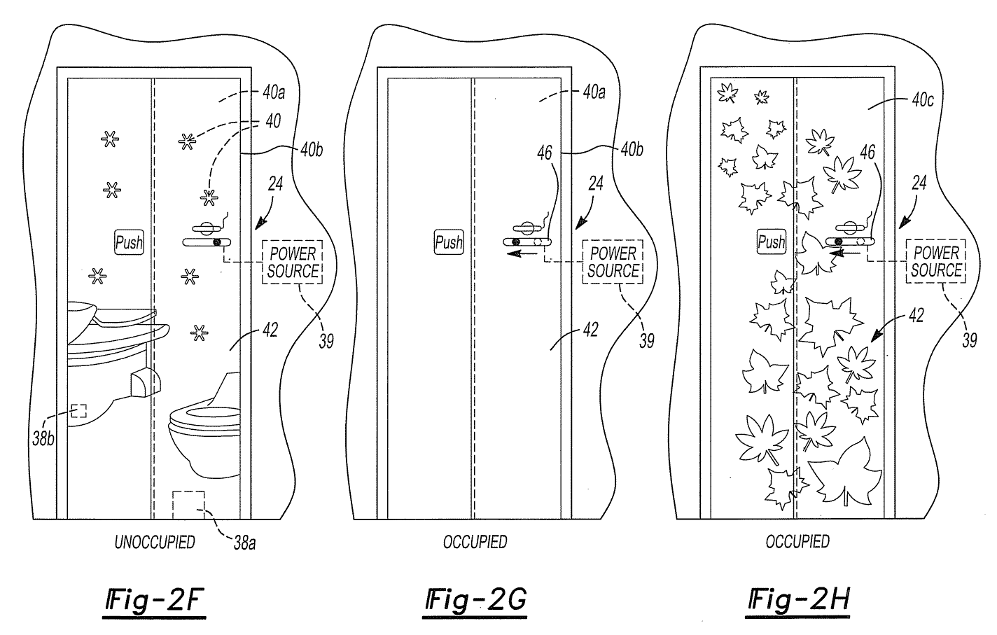

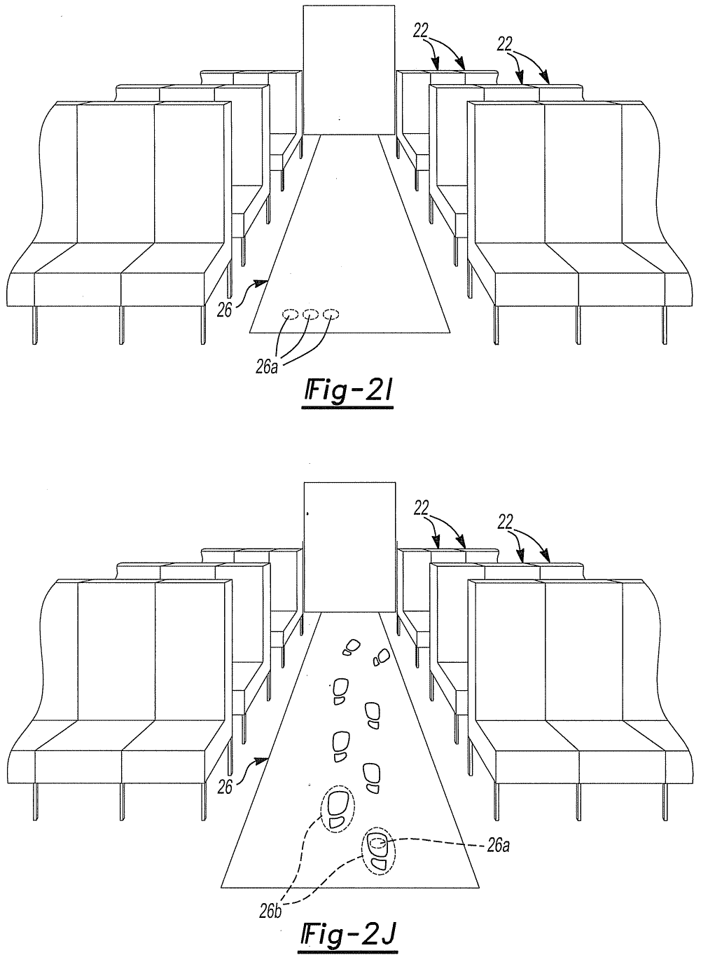

With reference to FIGS. 1 and 2A, the at least one crew area 20 may include a galley or galley complex 20a (FIG. 2A), and a control panel 28 (FIG. 1) in communication with and responsive to the controller 18 through either a wired or wireless connection (not specifically shown). With reference to FIG. 2A, the galley complex 20a may include at least one galley service apparatus 19, such as an oven 19a, a coffeemaker 19b, a refrigerator 19c, and one or more galley carts 1 9d. Each of the oven 1 9a, a coffeemaker 1 9b, a refrigerator 19c, and galley carts 19d may include one or more sensors 21, such as an oven sensor 21a, a coffeemaker sensor 21b, a refrigerator sensor 21c, and a cart lock sensor 21d. The sensors 21 may be in communication with and responsive to the controller 18 through either a wired or a wireless connection (not specifically shown).

The oven sensor 21 a may indicate when the oven 19a has reached a desired temperature, or when an item in the oven 19a is done cooking. Thus, the oven sensor 21a may be coupled to the oven 19a such that the oven sensor 21a is in thermal communication with the oven 19a. The coffeemaker sensor 21b may indicate when the coffeemaker 21b has completed brewing a pot of coffee, and thus, may be in communication with a water supply coupled to the coffeemaker 21b (not specifically shown). The refrigerator sensor 21c may indicate if the refrigerator 19c is unlatched, and similarly, the cart lock sensor(s) 21d may indicate if the galley carts 19d are unlatched or unsecured relative to the galley complex 20a. Thus, the refrigerator sensor 21c may be coupled to a latch 19c′ of the refrigerator 19c, and the cart lock sensor(s) 21d may be coupled to a latch 19d′ on the galley carts 19d. With reference to FIG. 1, the control panel 28 can enable the crew to interface with the architecture communication control module 10. Thus, the control panel 28 may include at least one user input device and display means, such as a GUI for example, however, any suitable user input device and display means could be employed, such as button(s), a touch screen, a mouse, a stylus and/or a display screen (not specifically shown).

With reference to FIGS. 1 and 2B, the passenger seat 22 includes a seat sensor 22a and a seatbelt 30. The seat sensor 22a may comprise a weight sensor in communication with and responsive to the controller 18 to indicate whether the passenger seat 22 is occupied. With reference to FIG. 2B, the seatbelt 30 includes a first belt member 30a that mates with and may be released from a second belt member 30b. For example, the first belt member 30a may have a buckle 32 that engages an insert 34 coupled to the second belt member 30b. The buckle 32 may also include a sensor 36 that is in communication with and responsive with the controller 18 through a wired or wireless connection (not specifically shown). The sensor 36 may transmit a signal that the seatbelt 30 is latched or unlatched. The sensor 36 may comprise an energy harvesting switch such that the sensor 36 does not require an external source of power from the aircraft 8 to function. Exemplary energy harvesting switches could be provided by EnOcean GmbH of Oberhaching, Germany. If the sensor 36 comprises an energy harvesting switch, the switch could be configured so that when the switch is closed (by the insertion of the insert 34 into the buckle 32), the switch transmits the signal to the controller 18 that the seatbelt 30 is fastened. Further, with reference to FIG. 2C, if a switch is employed as the sensor 36, one or more light sources 36a, such as light emitting diodes, incandescent light source, fluorescent light source, fiber optic light source, organic light emitting diodes, etc., could be in communication with the switch such that the light sources 36 output a first color, such as red, when the seatbelt 30 is unfastened, and a second color, such as green, when the seatbelt 30 is fastened. The seatbelt 30 may also be in contact with various other control systems onboard the aircraft 8 such that in cases where a no smoking, fasten seatbelts (NSFSB) sign is on and passengers must be wearing their seatbelts 30, the light sources 36a may flash red to indicate that the passenger must fasten their seatbelts 30, for example. In cases where the ambient cabin lighting was set to low, the architecture communication control module 10 could set the light sources 36a to illuminate with a low intensity when the seatbelt 30 is fastened, but the light sources 36a may return to a higher intensity when the seatbelt 30 is to be fastened.

Further, in addition to light sources 36a, materials, such as a heat activated display material could be used to communicate that the seatbelt 30 should be fastened. For example, at least one of the first belt member 30a and second belt member 30b could be comprised of the heat activated material disclosed in U.S. Pat. No. 6,580,413, assigned to the United States of America, and hereby incorporated by reference. The first belt member 30a and/or second belt member 30b could also comprise a heat activated display, such as that available from the Hong Kong University of Science and Technology, in China.

In addition, with reference to FIG. 2D, the first belt member 30a and/or the second belt member 30b may be comprised of a shape memory alloy material, and may include a power source 37 coupled to at least one or both of the first belt member 30a and the second belt member 30b. For example, at least one of the first belt member 30a and the second belt member 30b could comprise helical super elastic nitinol wire, such as Biometal® Micro Helix available commercially from the Toki Company of Tokyo, Japan. As a further example, the seatbelt 30 could be comprised of an electroactive polymer, such as ionic muscle available commercially from Environmental Robots, Inc. of Albuquerque, N.Mex., or Eamex Corporation of Osaka, Japan. The power source 37 may be in communication with and responsive to the controller 18 through a wired or wireless connection (not specifically shown) to apply a current to one or more of the first belt member 30a and the second belt member 30b to change the shape of at least one of the first belt member 30a and the second belt member 30b. For example, each or both of the first belt member 30a and the second belt member 30b may have a first state, in which the first belt member 30a and the second belt member 30b are of a conventional shape, as shown in FIG. 2D. In a second state, as shown in FIG. 2E, at least one of the first belt member 30a and the second belt member 30b may have a different shape (indicated generally at A) to indicate that the seatbelt 30 should be fastened.

With reference to FIG. 1, the lavatory 24 may comprise a standard lavatory, as known in the art, and thus, the lavatory 24 will not be discussed in great detail herein. Briefly, however, with reference to FIG. 2F and 2G, the lavatory 24 includes an occupant sensor 38, wall covering 40 that includes an interior wall covering 40a and an exterior wall covering 40b, and a door 42. The occupant sensor 38 generates a signal that indicates whether a passenger is in the lavatory 24, such as a weight sensor 38a or a radio frequency identification (RFID) sensor 38b. The occupant sensor 38 is in communication with and responsive to the controller 18 through a wired or a wireless connection (not specifically shown). If the lavatory 24 includes the weight sensor 38a, then a weight of the passenger may be used to determine if the lavatory 24 is occupied. If the lavatory 24 includes the RFID sensor 38b, then a RFID tag 38c coupled to the passenger (FIG. 2B) may be used to determine if the lavatory 24 is occupied. The RFID tag 38c of the passenger may also be used to by the architecture communication control module 10 to identify the passenger seat 22 assigned to the passenger and passenger preferences, as will be discussed.

With reference to FIG. 2F, the wall covering 40 may comprise an image that may be displayed or coupled to one or more interior surfaces 44 of the lavatory 24 based on the preferences of the user retrieved from the RFID tag 38c (FIG. 2B) or based on whether the lavatory 24 is occupied. The wall covering 40 may comprise a magnetic wall covering, which could be provided by MagScapes of London, United Kingdom, or color changing wall covering, such as the color changing transuient panels manufactured by 3-Form of Salt Lake City, Utah. The wall covering 40 could also comprise a heat sensitive wall covering, such as a heat sensitive wallpaper available from Shi Yuan of the United Kingdom. Further, the wall covering 40 could comprise a color changing wall paint, such as Eclipse paint available commercially from Alsa Corporation of Vernon, California. The wall covering 40 could also comprise a color changing ink, such as an ultraviolet color changing ink available commercially from SolarActive® International, Inc. of Tarzana, Calif. The wall covering 40 could further comprise a pattern of one or more organic light emitting diodes (OLEDs) that may decorate the interior wall covering 40a. The interior wall covering 40a could also be comprised of an electronic paper display that may enable an occupant of the lavatory 24 to draw on the interior wall covering 40a of the lavatory 24, if desired. Exemplary electronic paper displays may be manufactured by E Ink Corporation of Cambridge, Mass.

Similarly, the exterior wall covering 40b could function to communicate to the cabin 16 that the lavatory 24 is occupied or empty. Further, it will be understood that the galley service apparatus 21 could include communicative wall coverings. For example, the galley carts 21d could have a wall covering that changes (based on RFID) to indicate if the galley cart 21d is empty or full and/or properly secured. In one example, the oven 21a may include a thermal responsive covering that indicates that the oven 21a is at a cooking temperature (i.e. hot). In addition, the refrigerator 21c may include a thermal responsive covering that indicates that the refrigerator 21c is at a cooling temperature (i.e. cold), for example. In one example, the coffeemaker 21b may include a thermal responsive covering that indicates that the coffee in the coffeemaker 21 b is hot and/or full. Thus, it will be understood that the applications described herein are merely exemplary, and the coverings disclosed herein could be applied to any appropriate surface and/or apparatus.

The door 42 provides access to the lavatory 24. The door 42 may be comprised of a material that enable the status of the lavatory 24 (i.e. occupied, unoccupied, unavailable due to turbulence, etc.) to be displayed or communicated to the passengers onboard the aircraft 8. For example, the door 42 could be composed at least partially of an electrochromatic glass such as Glass™ SwitchLite Privacy, available commercially from Pulp Studio, Inc. of Los Angeles, Calif. If the door 42 is composed of an electrochromatic glass, then the door 42 may be transparent when a latch 46 on the door 42 is unlatched (unoccupied), as illustrated in FIG. 2F, and the door 42 may be opaque when the latch 46 is latched (occupied), as illustrated in FIG. 2G. In this regard, a power source 39 could be in communication with and responsive to the controller 18 through a wired or wireless connection (not specifically shown), and the latch 46 could also be in communication with and responsive to the controller 18 through a wired or wireless connection (not specifically shown). When the latch 46 is latched, then the controller 18 may activate the power source 39 to apply a current to the electrochromatic glass. This enables an opacity of the door 42 to change from transparent (unoccupied; FIG. 2F) to opaque (occupied; FIG. 2G) due to the application of the current. In addition, with reference to FIG. 2H, the door 42 could have a wall covering 40c that may change when the lavatory 24 is occupied. In this regard, the power source 39 may apply a current to the door 42, when the latch 46 is latched, that causes the wall covering 40c to change as discussed with regard to the wall covering 40. In addition, the lavatory 24 may include an indicator on an interior surface of the lavatory 24 that indicates if the lavatory 24 is fully latched (not specifically shown).

With reference to FIG. 1 and 21 the flooring 26 covers the cabin 16 of the aircraft 8. The flooring 26 may include one or more illumination devices 26a, such as one or more light emitting diodes or one or more optical fibers. The illumination devices 26a may be in communication with or responsive to the controller 18. The flooring 26 could be used to communicate when it is appropriate for a passenger to leave the passenger seat 22. When it is appropriate for the passenger to move about the cabin 16, and cabin service carts do not need the aisle, the flooring 26 could be illuminated in a different color, such as blue, and when the passengers need to remain seated due to expected turbulence or cabin crew service needs, the flooring 26 could be illuminated in a different color, such as red. In addition, with reference to FIG. 2J, the illumination devices 26a could be coupled to the flooring 26 in defined patterns, such as footsteps 26b, for example, to direct a passenger to an aisle including their assigned passenger seat 22 in cases with low lighting in the cabin 16. In one example, the illumination device 26a could comprise programmable organic light emitting diodes, or programmable light emitting diodes that may be operable to illuminate in specified patterns or in response to a weight input, such as the weight of the passenger. The controller 18 may comprise a computer and/or processor, and memory to hold instruction and data related to the architecture communication control module 10.

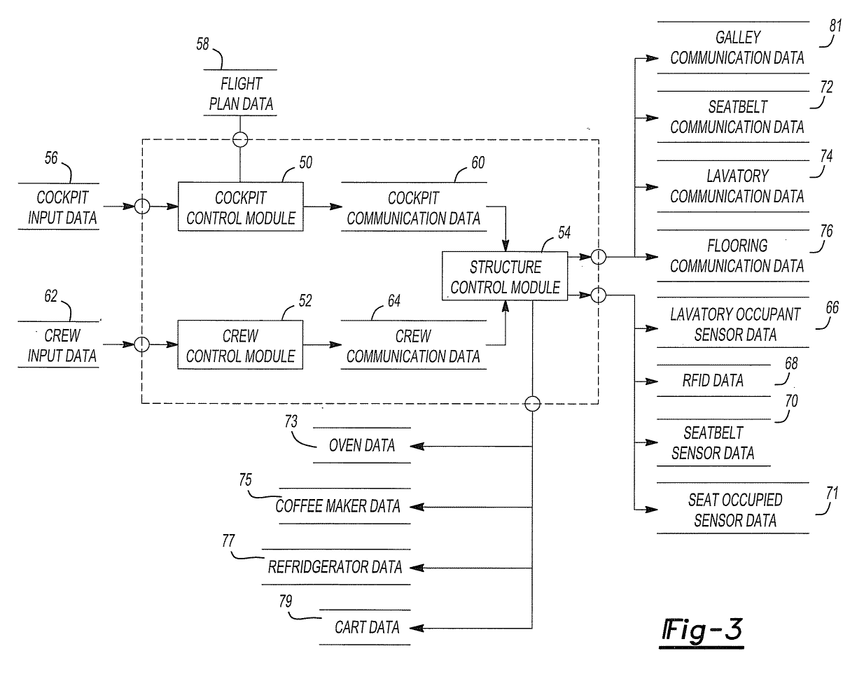

With reference to FIG. 3, the architecture communication control module 10 for the aircraft 8 is illustrated in accordance with the teachings of the present disclosure. The architecture communication control module 10 enables occupants of the cockpit 14 and the crew on the aircraft 8 to communicate with the passengers onboard the aircraft 8 via the architecture or structure on the aircraft. In this regard, the architecture communication control module 10 enables the occupants of the cockpit 14 and crew to communicate information to the passengers and crew via the seatbelt 30, lavatory 24, galley complex 20a, and flooring 26 without requiring placards or other external displays. Thus, the architecture communication control module 1 0 may enable passengers with disabilities to understand and respond to the information provided by the seatbelt 30, lavatory 24, galley complex 20a, and the flooring 26.

As used herein, the term “module” refers to an application specific integrated circuit (ASIC), an electronic circuit, a processor (shared, dedicated, or group) and memory that executes one or more software or firmware programs, to a combinational logic circuit, and/or to other suitable components that provide the described functionality. In FIG. 3, a dataflow diagram illustrates various components of an architecture communication system that is embedded within the architecture communication control module 10. Various embodiments of the architecture communication control module 10 may include any number of sub-modules embedded within the architecture communication control module 10. The sub-modules shown in FIG. 3 may be combined and/or further partitioned to similarly control the architecture communication onboard the aircraft 8. Inputs to the architecture communication control module 10 are received from other control modules (not shown) within the aircraft 8, and/or determined by other sub-modules (not shown) within the architecture communication control module 10 (not shown). In FIG. 3, the architecture communication control module 10 includes a cockpit control module 50, a crew control module 52 and a structure control module 54.

The cockpit control module 50 receives as input cockpit input data 56 and flight plan data 58. The cockpit input data 56 comprises user input received via the user input device 19 in the cockpit 14. Generally, the cockpit input data 56 may comprise a request to communicate to the passengers to fasten their seatbelts 30. The flight plan data 58 comprises data associated with the scheduled route of travel of the aircraft 8, and thus, may comprise data associated with an anticipated departure time from an airport, a time to reach a cruising altitude, expected turbulence, a time of descent into an airport and a time to taxi to or from a terminal gate of an airport. Based on the cockpit input data 56 and flight plan data 58, the cockpit control module 50 sets cockpit communication data 60 for the structure control module 54. The cockpit communication data 60 comprises the information requested to be communicated to the passengers by one or more structures in the aircraft 8, as will be discussed. For example, the cockpit communication data 60 may comprise information that the aircraft 8 is taxing to or from the terminal gate of an airport, preparing for take-off from a runway, starting a descent and/or information to fasten seatbelts until the aircraft 8 reaches a cruising altitude or until the aircraft 8 has passed through turbulence.

The crew control module 52 receives crew input data 62. The crew input data 62 may comprise information to be communicated to the passengers via the structure on the aircraft 8, such as information to fasten seatbelts, information that an announcement is about to be made or information that food service is about to begin. The crew input data 62 may be input by the crew through the control panel 28. Based on the crew input data 62, the crew control module 52 sets crew communication data 64 for the structure control module 54. The crew communication data 64 comprises the information requested to be communicated to the passengers by one or more structures in the aircraft 8, as provided by the crew through the control panel 28.

The structure control module 54 receives as input the cockpit communication data 60, the crew communication data 64, lavatory occupant sensor data 66, RFID data 68, seatbelt sensor data 70, seat occupied sensor data 71, oven data 73, coffeemaker data 75, refrigerator data 77 and cart data 79. The lavatory occupant sensor data 66 comprises a signal from the occupant sensor 38, such as the weight sensor 38a, that indicates whether the lavatory 24 is occupied. The RFID data 68 comprises data received from the RFID sensor 38c coupled to the passenger, such as the assigned seat of the passenger or the passenger preference for lavatory lighting, temperature, air flow, or wall pattern, etc. The seatbelt sensor data 70 comprises a signal from the sensor 36 coupled to the seatbelt 30 that the seatbelt 30 is fastened. The seat occupied sensor data 71 comprises data from the seat sensor 22a that indicates if the passenger seat 22 is occupied. The oven data 73 comprises a signal from the oven sensor 21a that the oven is at a desired temperature and/or that food in the oven is finished cooking. The coffeemaker data 75 comprises a signal from the coffeemaker sensor 21b that the coffee is done brewing. The refrigerator data 77 comprises a signal from the refrigerator sensor 21c that the refrigerator is opened, or unlatched. The cart data 79 comprises a signal from the cart sensor 21d that indicates that the cart(s) is unlatched or unsecured in the galley complex 20a. Based on the cockpit communication data 60, the crew communication data 64, the lavatory occupant sensor data 66, the RFID data 68, the seatbelt sensor data 70, and the seat occupied sensor data 71, the structure control module 54 outputs seatbelt communication data 72, lavatory communication data 74, flooring communication data 76 and galley communication data 81.

The seatbelt communication data 72 comprises a requested communication function for the seatbelt 30 to perform. For example, the seatbelt communication data 72 may comprise a request to communicate to the passenger, via the seatbelt 30, that the seatbelt 30 should be fastened. Thus, if light sources 36a are coupled to the seatbelt 30, the light sources 36a may be illuminated red or flashing red, for example, to indicate that the seatbelt 30 should be fastened. In addition, if the seatbelt 30 comprises a shape memory alloy material, the seatbelt communication data 72 may comprise a signal to apply a current to the seatbelt 30 via the power source 37 to change the shape of the seatbelt 30 to indicate that the seatbelt 30 should be fastened. Further, for example, in cases where the No Smoking Fasten Seatbelt (NSFSB) is on and the passenger seat 22 is occupied, but the seatbelt 30 is not fastened the light sources 36a on the seatbelt 30 could flash red. In one example, in cases where the NSFSB is off and the passenger seat 22 is occupied, but not the seatbelt 30 is not fastened, the light sources 36a could be illuminated a solid red. A further example, in cases where the passenger seat 22 is occupied and the seatbelt 30 is fastened correctly, the light sources 36a could be illuminated green.

The lavatory communication data 74 comprises a status of the lavatory 24, which may be communicated by the door 42 of the lavatory 24. For example, the door 42, via the application of the power source 39 may indicate that the lavatory 24 is occupied, unoccupied, available for use or unavailable. In addition, lavatory communication data 74 may comprise desired wall covering 40 for the interior surfaces 44 of the lavatory 24 based on the preferences of the user or passenger in the lavatory 24.

The flooring communication data 76 comprises information to be communicated by the flooring 26 by the illumination devices 26a, such as the current operating status of the aircraft 8 (i.e. take-off, descent, turbulence), and/or the current operations of the crew (i.e. announcement, food service). In addition, the flooring communication data 76 may comprise which of the illumination devices 26a to illuminate in order to guide the passenger from the lavatory 24 back to their assigned seat, given the RFID tag 38c associated with the passenger and the exit of the passenger from the lavatory 24. The galley communication data 81 comprises information to be communicated to the crew members in the galley complex 20a, such as whether the oven 19a is at a proper temperature, the food in the oven 19a is finished cooking, the coffeemaker 19b is finished brewing or full, the refrigerator 19c is opened or at temperature, or one or more galley carts 19d are unlatched from the galley complex 20a. For example, with reference to FIG. 2K, the flooring 26 could comprise illuminated footsteps 26b that may guide the passenger to their passenger seat 22.

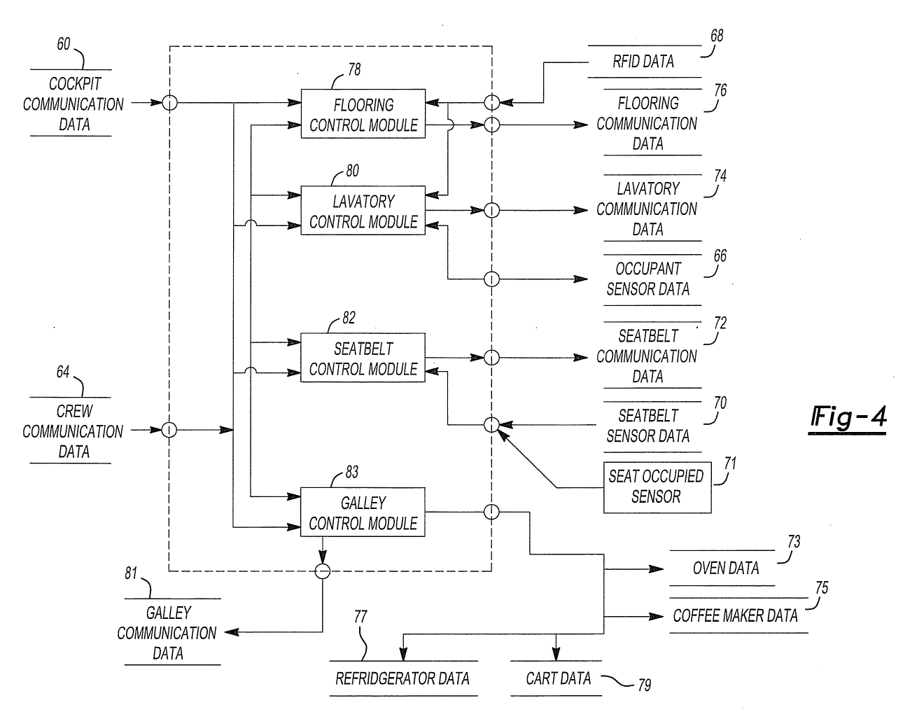

With reference to FIG. 4, a dataflow diagram illustrates an exemplary structure control system that may be embedded within the structure control module 54. The structure control module 54 includes a flooring control module 78, a lavatory control module 80 a seatbelt control module 82, and a galley control module 83. The flooring control module 78 receives as input the cockpit communication data 60, crew communication data 64 and the RFID data 68. Based on the cockpit communication data 60, crew communication data 64 and the RFID data 68, the flooring control module 78 outputs the flooring communication data 76. As discussed, the flooring communication data 76 comprises an illumination scheme for the flooring 26 to communicate messages from the occupants of the cockpit 14 and the crew, and to also communicate or guide the passenger to their assigned passenger seat 22 from the lavatory 24.

The lavatory control module 80 receives as input the cockpit communication data 60, crew communication data 64 and the occupant sensor data 66. Based on the cockpit communication data 60, crew communication data 64 and the occupant sensor data 66, the lavatory control module 80 outputs the lavatory communication data 74. As discussed, the lavatory communication data 74 comprises a visual communication through changes to the wall covering 40 or the door 42 of whether the lavatory 24 is occupied, unoccupied, available or unavailable, and also may comprise a desired wall covering 40 for the interior surfaces 44 of the lavatory 24 based on the preferences of the user in the lavatory 24.

The seatbelt control module 82 receives as input the cockpit communication data 60, crew communication data 64, the seat occupied sensor data 71 and the seatbelt sensor data 70. Based on the cockpit communication data 60, crew communication data 64, the seatbelt sensor data 70, and the seat occupied sensor data 71, the seatbelt control module 82 outputs the seatbelt communication data 72. As discussed, the seatbelt communication data 72 comprises a visual communication to the passenger as to whether the seatbelt 30 should be fastened, is not fastened correctly, or is fastened correctly.

The galley control module 83 receives as input the cockpit communication data 60, the crew communication data 64, the oven data 73, the coffeemaker data 75, the refrigerator data 77 and the cart data 79. Based on the cockpit communication data 60, the crew communication data 64, the oven data 73, the coffeemaker data 75, the refrigerator data 77 and the cart data 79, the galley control module 83 outputs the galley communication data 81. As discussed, the galley communication data comprises a visual communication of whether the oven is at a proper temperature, the food in the oven is finished cooking, the coffeemaker is finished brewing, the refrigerator is opened, or one or more carts are unlatched from the galley complex 20a.

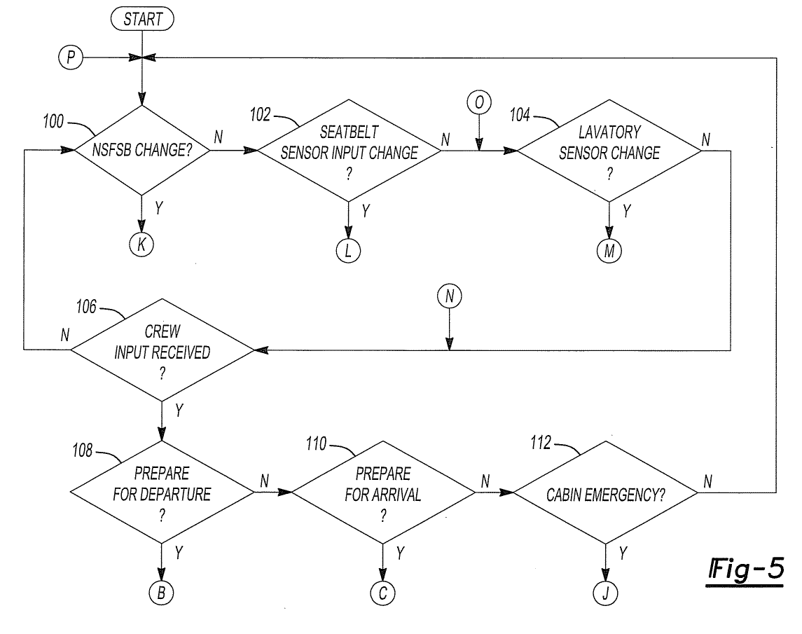

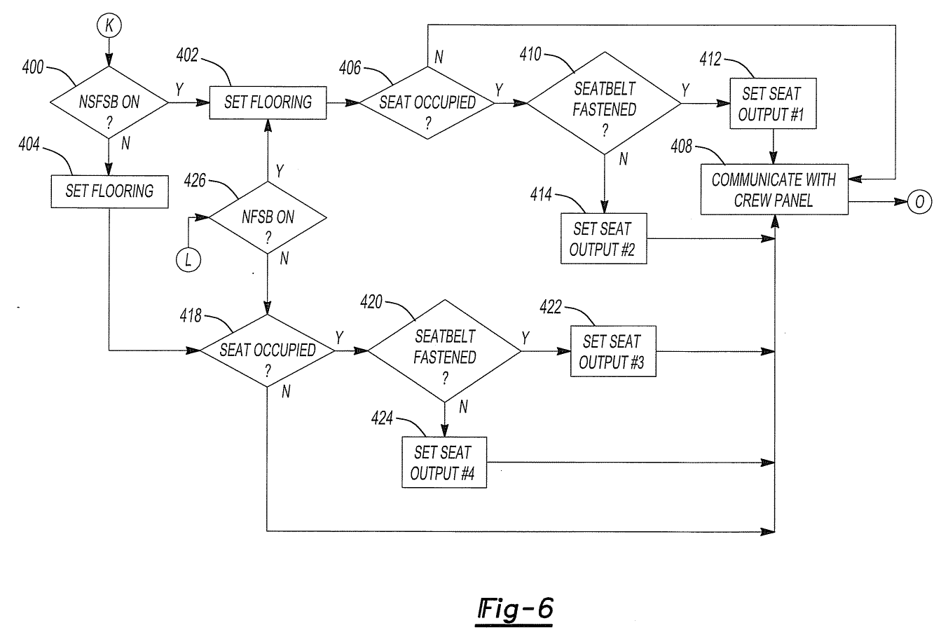

With reference to FIG. 5, a process flow diagram illustrates an exemplary operational sequence performed by the architecture communication control module 10. At operation 100, the method determines if the NSFSB sign has changed. If the NSFSB sign has changed, then the method goes to “K” on FIG. 6. Otherwise, the method goes to operation 102.

With reference to FIG. 6, at operation 400, the method determines if the NSFSB sign is enabled or active. If the NSFSB sign is active, then the method goes to operation 402. Otherwise, the method goes to operation 404. At operation 404, the method sets the flooring 26 to indicate that the passengers should not move about the cabin 16 and should remain seated in the passenger seats 22. Then, at operation 406, the method determines if the passenger seat 22 is occupied, based on input from the seat sensor 22a (FIG. 1), If the passenger seat 22 is not occupied, then the method goes to operation 408. If the passenger seat 22 is occupied, then the method goes to operation 410. At operation 410, the method determines if the seatbelt 30 is fastened based on input from the sensor 36 (FIG. 2B). If the seatbelt 30 is fastened, then the method goes to operation 412. At operation 412, the method sets the seatbelt 30 to communicate to the passenger that the seatbelt 30 is properly fastened during the activation of the NSFSB sign. For example, the light sources 36a on the seatbelt 30 could be illuminated to indicate that the seatbelt 30 is properly fastened, or the power source 37 could be deactivated to place the seatbelt 30 in the second state. In one example, the light source 36a could be set to illuminate solid green. Then, the method goes to operation 408.

If at operation 410, the seatbelt 30 is not properly fastened, then the method sets seatbelt 30 to indicate that the seatbelt 30 is not properly fastened as required with the NSFSB sign on at operation 414. For example, the light sources 36a on the seatbelt 30 could be illuminated to indicate that the seatbelt 30 is not properly fastened, and may be illuminated at a higher intensity or may flash. In one example, the light source 36a could be set to illuminate as flashing red. Further, the power source 37 could be activated to communicate that the seatbelt 30 is not properly fastened. Then, the method goes to operation 408. At operation 408, the method communicates the status of the seatbelt 30 to the control panel 28 in the crew area 20 (FIG. 1). Then, the method goes to “O” on FIG. 5.

At operation 400, if the NSFSB sign is off, then at operation 404 the method sets the flooring 26 to indicate that the passengers on the aircraft 8 may move about the cabin 16. At operation 418, the method determines if the passenger seat 22 is occupied. If the passenger seat 22 is not occupied, then the method goes to operation 408. Otherwise, the method goes to operation 420, in which the method determines if the seatbelt 30 is properly fastened. If the seatbelt 30 is properly fastened, then the method goes to operation 422. At operation 422, the method sets the seatbelt 30 to communicate to the passenger that the seatbelt 30 is properly fastened with the NSFSB sign not on. For example, the light sources 36a on the seatbelt 30 could be illuminated to indicate that the seatbelt 30 is properly fastened, or the power source 37 could be deactivated so that the seatbelt 30 is in the first state. It should be noted that the light sources 36a may be illuminated a different color or flashing pattern, such as yellow, or may be illuminated at a different intensity in operation 422, in contrast to the illumination of the light sources 36a in operation 412. The method then goes to operation 408.

If in operation 420, the seatbelt 30 is not properly fastened, then the method sets the seatbelt 30 to indicate to the passenger that the seatbelt 30 is not properly fastened with the NSFSB not on. As in this case, the seatbelt 30 is not required to be fastened, the light sources 36a on the seatbelt 30 could be illuminated at a lower intensity to indicate that the seatbelt 30 is not properly fastened, or the power source 37 could be activated so that the seatbelt 30 is in the second state. It should be noted that the light sources 36a may be illuminated a different color or in a flashing pattern, such as a solid red or flashing yellow, or may be illuminated at a different intensity in operation 422, in contrast to the illumination of the light sources 36a in operation 414. The method then goes to operation 408.

With reference back to FIG. 5, at operation 102, the method determines if the sensor 36 of the seatbelt 30 (FIG. 2B) has changed to indicate that the seatbelt 30 is fastened, unfastened or incorrectly fastened. If a status of the seatbelt 30 has changed, then the method goes to “L” on FIG. 6. Otherwise, the method goes to operation 104.

With reference to FIG. 6, at operation 426, the method determines if the NSFSB sign is enabled or active. If the NSFSB sign is active, then the method goes to operation 406. Otherwise, the method goes to operation 418.

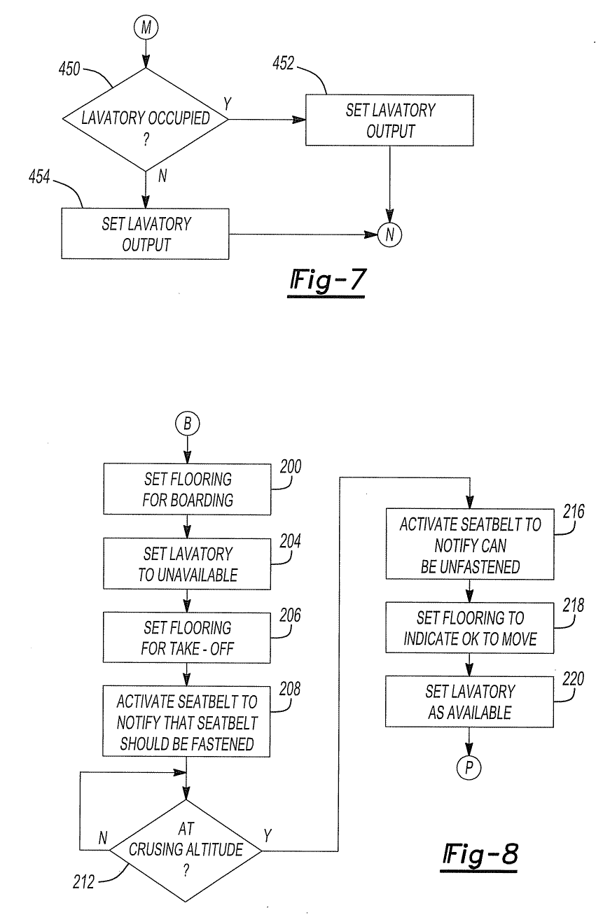

With reference back to FIG. 5, at operation 104, the method determines if a status of the lavatory 24 has changed, such that the occupant sensor 38 in the lavatory 24 indicates that the lavatory 24 is now occupied or unoccupied, then the method goes to “M” on FIG. 7. Otherwise, the method goes to operation 106.

With reference to FIG. 7, at operation 450, the method determines if the lavatory 24 is occupied based on the occupant sensor data 66 (FIG. 3). If the lavatory 24 is occupied, then the method goes to operation 452. At operation 452, the method sets the lavatory 24 to communicate to the passenger that the lavatory 24 is occupied. For example, the power source 39 could apply the current to the door 46 to change the door 46 to opaque, or could apply the current to the door 46 to change the wall covering 40c to indicate that the lavatory 24 is occupied. If the lavatory 24 is not occupied, then at operation 454, the method sets the lavatory 24 to communicate that the lavatory 24 is not occupied. For example, the door 46 could remain transparent, or the wall covering 40c could be devoid of a pattern or design that would otherwise indicate that the lavatory 24 is occupied. After operation 452 and 454, the method goes to “N” on FIG. 5.

With reference to FIG. 5, at operation 106, the method determines if crew input has been received via the control panel 28 (FIG. 1). If a crew input has been received, then the method goes to operation 108. Otherwise, the method loops to operation 100.

At operation 108, the method determines if the aircraft 8 is in preparation for departure. If the aircraft 8 is in preparation for departure, then the method goes to B on FIG. 8. Otherwise, the method goes to operation 110.

With reference now to FIG. 8, at operation 200, the method sets the flooring communication data 76 to communicate to the passengers that the aircraft 8 is boarding. At operation 204, the method sets the lavatory communication data 74 communicate that the lavatory 24 is unavailable. Then, the method goes to operation 206. At operation 206, the method sets the flooring communication data 76 to communicate that the aircraft 8 is preparing for take-off. At operation 208, the method activates the seatbelt 30 via the seatbelt communication data 72 to communicate to the passengers that the seatbelt 30 should be fastened.

At operation 212, after the seatbelt 30 has been fastened, the method determines if the aircraft 8 has reached a cruising altitude where the seatbelt 30 may be unfastened, and for passengers to move about the cabin 16. If the aircraft 8 has reached the cruising altitude, then the method goes to operation 216. Otherwise, the method loops until the aircraft 8 reaches the cruising altitude.

Once the aircraft 8 has reached the cruising altitude, then at operation 216, the method sets the seatbelt communication data 72 to communicate that the seatbelt 30 may be unfastened. At operation 218, the method sets the flooring communication data 76 to indicate that the passengers may safely move about the cabin 16. Then, at operation 220, the method sets the lavatory communication data 74 to indicate that the lavatory 24 is available for use. Then the method goes to “P” on FIG. 5.

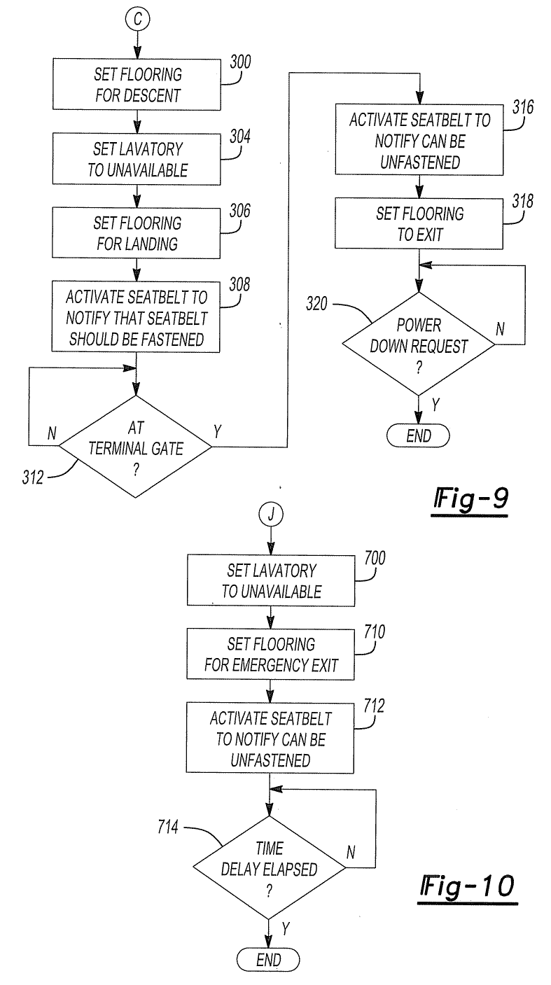

With reference to FIG. 5, at operation 110, the method determines if the aircraft 8 is in preparation for arrival. If the aircraft 8 is not in preparation for arrival, then the method goes to operation 112. Otherwise, the method goes to “C” on FIG. 9. With reference now to FIG. 9, at operation 300, the method sets the flooring communication data 76 to communicate via the flooring 26 that the aircraft 8 is preparing to descend into an airport. Then, the method goes to operation 304 where the lavatory communication data 74 is output to indicate that the lavatory 24 is unavailable. At operation 306, the method sets the flooring communication data 76 to communicate to the passengers that the aircraft 8 is preparing to land.

At operation 308, the method outputs the seatbelt communication data 72 to activate the seatbelt 30 to communicate to the passengers that the seatbelt 30 should be fastened. At operation 312, the method determines if the aircraft 8 is at the terminal gate of an airport. If the aircraft 8 is not at the terminal gate, then the method loops until the aircraft 8 arrives at the terminal gate. Otherwise, at operation 316, the method outputs the seatbelt communication data 72 to communicate to the passengers that the seatbelt 30 may be unfastened. At operation 318, the method sets the flooring communication data 76 to communicate to the passengers to exit the aircraft 8. At operation 320, the method determines if a power down request has been received via the cockpit communication data 60 or the crew communication data 64. If no power down request has been received, then the method loops until the power down request has been received. Otherwise, the method ends.

With reference back to FIG. 5, if the aircraft 8 is not in preparation for arrival, then at operation 112, the method determines if there is an emergency in the cabin 16. If there is no emergency in the cabin 16, then the method loops to operation 100. Otherwise, the method goes to “J” on FIG. 10.

With reference now to FIG. 10, at operation 700, the method outputs the lavatory communication data 74 to communicate to the passengers that the lavatory 24 is unavailable. Then, at operation 710, the method outputs the flooring communication data 76 to indicate the nearest emergency exit on the aircraft 8. Then, at operation 712, the method outputs the seatbelt communication data 72 to communicate to the passengers that the seatbelt 30 may be unfastened. Then, at operation 714, the method determines if a time delay has elapsed, and if not, loops until that time delay elapses. Then the method ends.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this disclosure, but that the scope of the present disclosure will include any embodiments falling within the foregoing description and the appended claims.

What is claimed is:

1. A system for communicating with at least one passenger onboard a mobile platform by using at least one structure onboard the mobile platform comprising:
at least one seat for receipt of the at least one passenger that includes a seatbelt that is operable to be fastened to retain the at least one passenger in the seat;
at least one source of data regarding a status of the mobile platform; and
a structure control module that generates communication data for at least the seatbelt based on the status of the mobile platform, the communication data operable to communicate to the at least one passenger by the seatbelt that the seatbelt is to be fastened.

2. The system of claim 1, wherein the source of data regarding the status of the mobile platform further comprises data from an occupant of a control center of the mobile platform, data from a crew member of the mobile platform, and data provided by at a planned route of travel of the mobile platform.

3. The system of claim 2, wherein the data from the occupant of the cockpit comprises cockpit communication data indicative of an emergency in the cockpit or a request for the seatbelt to be fastened.

4. The system of claim 2, wherein the data from the crew member comprises crew communication data that indicates that an announcement is to be made to the passengers, a food service is going to begin or a request for the seatbelt to be fastened.

5. The system of claim 2, wherein the mobile platform comprises an aircraft and the data from the planned route of travel comprises data associated with a flight plan of the aircraft.

6. The system of claim 1, further comprising:
at least one lavatory onboard the mobile platform for use by the at least one passenger; and
wherein the structure control module generates communication data for the at least one lavatory based on the status of the mobile platform, the communication data operable to communicate to the at least one passenger by the lavatory that the at least one lavatory is available or unavailable.

7. The system of claim 6, wherein the at least one lavatory further comprises at least one occupant sensor in communication with the structure control module to enable the structure control module to generate communication data to communicate to the at least one passenger by the lavatory that the at least one lavatory is occupied or unoccupied.

8. The system of claim 7, wherein the at least one lavatory further comprises a door in communication with the structure control module to receive the communication data, the door operable to communicate to the at least one passenger whether the at least one lavatory is available, unavailable, occupied or unoccupied.

9. The system of claim 1, wherein the seatbelt further comprises at least one light emitting device in communication with and responsive to the structure control module to receive the communication data, the at least one light emitting device operable to illuminate to communicate to the at least one passenger whether the seatbelt should be fastened or unfastened.

10. The system of claim 1, wherein the seatbelt further comprises at least one power source in communication with and responsive to the structure control module to receive the communication data, the at least one power source operable to apply a current to the seatbelt to change a state of the seatbelt to communicate to the at least one passenger whether the seatbelt should be fastened or unfastened.

11. The system of claim 1, wherein the mobile platform further comprises a flooring surface adjacent to the at least one seat, the flooring surface including at least one illumination device, the at least one illumination device in communication with the structure control module to receive the communication data, the at least one illumination device operable to illuminate the flooring surface to communicate the status of the mobile platform to the at least one passenger.

12. A method of communicating with passengers onboard a mobile platform by using at least one structure onboard the mobile platform comprising:
receiving an input from at least one of an occupant of a control center on the mobile platform and a crew member of the mobile platform;
determining, based on the input, a message to communicate to the passengers;
selecting the at least one structure onboard the mobile platform to communicate the message with, the at least one structure selected from the group comprising: flooring onboard the mobile platform, a lavatory onboard the mobile platform, a galley complex onboard the mobile platform, a seatbelt onboard the mobile platform and combinations thereof; and
communicating the message to the passengers via the selected at least one structure on the mobile platform.

13. The method of claim 12, wherein the message includes a request to fasten the seatbelt and communicating the message to the passengers further comprises:
illuminating at least one illumination device coupled to the flooring to communicate that the passengers are to remain seated; and
illuminating at least one light emitting device on the seatbelt to communicate that the seatbelt is to be fastened or applying a current to the seatbelt to change a shape of the seatbelt to communicate to the passengers that the seatbelt is to be fastened.

14. The method of claim 12, wherein the message is a status of at least one lavatory on the mobile platform and communicating the message to the passengers further comprises:
providing a door on the at least one lavatory that is responsive to a signal to change opacity between opaque and transparent;
communicating that the at least one lavatory is occupied by changing the opacity of the door to opaque; and
communicating that the at least one lavatory is unoccupied by changing the opacity of the door to transparent.

15. The method of claim 14, wherein the message comprises a status of an impending departure or an impending arrival of the mobile platform and communicating the message to the passengers further comprises:
illuminating at least one illumination device coupled to the flooring to communicate the impending departure or the impending arrival of the mobile platform;
illuminating at least one light emitting device on the seatbelt to communicate that the seatbelt is to be fastened or applying a current to the seatbelt to change a shape of the seatbelt to communicate to the passengers that the seatbelt is to be fastened; and
changing the opacity of the door to communicate to the passengers that the lavatory is unavailable for use.

16. An aircraft comprising:
a fuselage that includes a cabin and a cockpit, with the cabin including at least one passenger seat having a seatbelt, at least one lavatory, at least one galley complex and flooring, with the seatbelt of the at least one passenger seat, the at least one lavatory, the at least one galley complex and the flooring controlled by a communication system including:
an architecture communication control module that generates communication data that communicates at least information received from an occupant of the cockpit to at least one passenger onboard the aircraft through the seatbelt of the at least one passenger seat, the at least one lavatory, the at least one galley complex, the flooring and combinations thereof.

17. The aircraft of claim 16, wherein the architecture communication control module communicates information received from a crew member of the aircraft to the at least one passenger onboard the aircraft.

18. The aircraft of claim 16, wherein the architecture communication control module communicates a request to fasten the seatbelt to the at least one passenger through the seatbelt of the at least one passenger seat.

19. The aircraft of claim 16, wherein the at least one lavatory further comprises:
at least one occupant sensor coupled to the at least one lavatory, the at least one occupant sensor in communication with and responsive to the architecture communication control module to transmit a signal that indicates if the at least one lavatory is occupied;
a door coupled to the at least one lavatory, the door in communication with and responsive to the architecture communication control module to change opacity from transparent to opaque; and
wherein the architecture communication control module communicates whether the at least one lavatory is occupied, unoccupied, available or unavailable by changing the opacity of the door.

20. The aircraft of claim 16, wherein the architecture communication control module communicates to the at least one passenger that the aircraft is preparing for departure from an airport or preparing for arrival into an airport through the flooring.

21. A system for communicating with at least one passenger onboard an aircraft having a fuselage that includes a cabin and a cockpit, the cabin including at least one passenger seat having a seatbelt, at least one lavatory, at least one galley complex and flooring, the system comprising:
at least one food service preparation device located within the galley complex, the at least one food service device including at least one sensor;
at least one source of data regarding a status of the aircraft;
at least one occupant sensor coupled to the at least one lavatory, the at least one occupant sensor operable to transmit a signal that indicates if the at least one lavatory is occupied;
a seatbelt control module that generates communication data for at least the seatbelt based on the status of the aircraft, the communication data operable to communicate to the at least one passenger by the seatbelt that the seatbelt is to be fastened;
a galley control module that generates communication data for at least the at least one food service preparation device that indicates that the at least one food service preparation device is ready for service;
a lavatory control module that generates communication data for the at least one lavatory based on the signal from the at least one occupant sensor, the communication data operable to communicate to the at least one passenger by the lavatory that the at least one lavatory is occupied or unoccupied; and
a flooring control module that generates communication data for the flooring such that the flooring is operable to communicate the status of the aircraft to the at least one passenger.

22. A method of communicating with passengers onboard an aircraft having a fuselage that includes a cockpit and a cabin that includes at least one passenger seat having a seatbelt, at least one lavatory, at least one galley complex and flooring comprising:
receiving an input from at least one of an occupant of the cockpit or a crew member of the aircraft;
determining, based on the input, a message to communicate to the passengers;
communicating the message to the passengers by at least one of:
illuminating the flooring to communicate the message;
illuminating at least one light source on the seatbelt to communicate the message or applying a current to the seatbelt to change a shape of the seatbelt to communicate the message;
changing a door coupled to the lavatory to communicate the message;and
combinations thereof.
